(19) United States
(12) Patent Application Publication
(10) Pub. No.: US 2026/0208886 A1
(43) Pub. Date: Jul. 23, 2026

(54) RESETTABLE HOLD DOWN AND RELEASE MECHANISM INCLUDING A SPLIT SPOOL

(71) Applicant: Ensign-Bickford Aerospace & Defense Company, Simsbury, CT (US)

(72) Inventor: Luke K. Ionno, Colchester, CT (US)

(21) Appl. No.: 19/451,011

(22) Filed: Jan. 16, 2026

Related U.S. Application Data
(60) Provisional application No. 63/746,344, filed on Jan. 17, 2025.

(51) Int. Cl. B64G 1/64; B64G 1/00

(52) U.S. Cl. CPC B64G 1/6457; B64G 1/005

(57) ABSTRACT

A hold down and release mechanism for a vehicle includes a base plate; a spool assembly including a first spool member and a second spool member in operable contact with the base plate; a release barrel positioned around the spool assembly; a pair of rollers provided between the spool assembly and the release barrel, the pair of rollers configured to roll along an outer surface of the spool assembly; and a trigger pack operably coupled to the release barrel, wherein the spool assembly is configured to separate in response to an input from the trigger pack.

### CROSS-REFERENCE TO RELATED APPLICATIONS

This application claims the benefit of U.S. Provisional Patent Application No. 63/746,344, filed on January 17, 2025. The entire contents of the aforementioned application is incorporated herein by reference.

### BACKGROUND

The subject matter disclosed herein relates in general to hold down and release mechanisms, and more particularly to hold down and release mechanisms for use on satellites or other spacecraft.

Components of a launch vehicle may need to be separated during flight to jettison stages and components that are no longer needed, to uncover equipment, or release a payload into orbit for example. Components of a launch vehicle may also need to be separated to deploy payloads, or unlocked for deployment, e.g. for solar arrays. Once the launch vehicle reaches a destination or desired orbit characteristic, then payload satellites, probes, or other payloads can be deployed and placed into a functioning mode. Payloads, for example satellites, can be carried by launch systems, such as space vehicles, into orbit or other destinations in space. Satellites can be placed into Earth orbit (or into orbit around other bodies) to perform various tasks, such as sensing, surveillance, communications, or scientific experimentation.

Existing mechanisms or systems for releasing payloads (e.g., satellites) in space exhibit several drawbacks. For instance, existing release mechanisms incorporate complex actuator assemblies involving a plurality of moving parts, increasing the potential for undesirable results or malfunctions. Moreover, existing release systems can be difficult to reuse by incorporating non-resettable features or requiring rebuilds in order to be reused.

Accordingly, a hold down and release mechanism which obviates one or more of the above-mentioned drawbacks would be beneficial. In particular, a hold down and release mechanism including resettable features and improved actuation would be useful.

### BRIEF DESCRPTION

According to one aspect of the disclosure, a hold down and release mechanism is provided. The device includes a base plate, a spool assembly, a release barrel, and a pair of rollers.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 provides an exploded view of a hold down and release mechanism according to exemplary embodiments of the present disclosure.

FIG. 2 provides a side section view of the exemplary hold down and release mechanism of FIG. 1.

FIG. 3 provides a top section view of the exemplary hold down and release mechanism of FIG. 1 with a release barrel in a loaded position.

FIG. 4 provides a top section view of the exemplary hold down and release mechanism of FIG. 1 including a trigger pack and an actuator.

FIG. 5 provides a perspective view of the trigger pack of FIG. 4 according to exemplary embodiments of the present disclosure.

FIGS. 6A, 6B, and 6C provide sequential top views of the exemplary hold down and release mechanism of FIG. 1 from a loaded position to a released position.

FIG. 7 provides a perspective view of the exemplary hold down and release mechanism of FIG. 1 showing a spring guide, a driving spring, and a shock absorber.

FIG. 8 provides a flow chart illustrating a method of operating a hold down and release mechanism according to exemplary embodiments of the present disclosure.

FIG. 9 provides top views of additional exemplary embodiments of a spool member of the hold down and release mechanism of FIG. 1.

### DETAILED DESCRIPTION

Embodiments disclosed herein provide for a hold down and release mechanism, such as that used on a rocket or launch vehicle to place satellites into orbit.

Generally, release mechanisms include non-explosive actuators (NEA) such as NEAs manufactured by Ensign Bickford Aerospace and Defense (EBAD) located in Simsbury, CT. These prior art mechanisms secure the payload to the launch vehicle. However, these mechanisms can only be used once. In some instances, it is desirable to provide a release mechanism that is field-resettable. This provides advantages in allowing the release mechanisms to be tested prior to launch. As with the NEA devices, embodiments of the present disclosure employs a split spool to release a preloaded axial component (the release rod), when voltage/current is supplied to the device. The overall form-factor and preload capacity versus device volume are also comparable those of an NEA.

According to some embodiments, the trigger mechanism is driven by a titanium-nickel (TiNi) wire. In this respect, the present disclosure also has similarities with the EBAD electric release mechanism (ERM) family of devices, such as U.S. Pat. No. 11,976,640 which is hereby incorporated by reference in its entirety; however, it offers significantly higher preload for a given size/volume.

Embodiments of the present disclosure are configured to release payloads retained by a preloaded release rod, with a common example of usage being releasing satellites from launch vehicles, using multiple instances of the present disclosure to retain a single satellite. With that said, embodiments of the present disclosure can be used in any application where an axial load must be carried and subsequently released in response to an electrical signal. Accordingly, embodiments of the present disclosure exhibit high preload to mass ratio as compared with other conventional hold down and release mechanisms.

While the present disclosure describes using a split spool that is functionally similar to that of an NEA, embodiments provided herein include the two halves of the spool being held together with roller-element bearings acting against the outside surfaces of the split spool halves, and the inside of a release barrel, instead of the wire wrappings of an NEA. This arrangement allows the device to be easily reset in the field, unlike NEAs, which must be returned to the manufacturer for refurbishment. At the same time, the use of rolling (rather than sliding) motion at the first stage of the release mechanism means that the friction forces are minimized, and are independent of the coefficient of static friction between the split spool, rollers and release barrel.

The arrangement of the rollers is also unlike other similar devices (e.g. other split nut or split spool designs), in that the split spool geometry is designed to make the rollers self-driving in response to preload forces, unlike other devices that were designed such that the rollers have no tendency to drive the mechanism, and instead depend on springs to actuate the rollers. By making the rollers self-driving, the forces driving the remainder of the release mechanism (and reacted by the trigger) can be tailored over the duration of the release event. Combined with the moment of inertia of the release barrel fitting, this allows adjustment of the duration of the release event itself – with appropriate values, this can be used to minimize source shock, arising from the contraction of the release rod, as the preload is relieved.

The use of cylindrical rollers and rolling motion also allows a more compact form-factor for a given preload, compared to an ERM (which employs a ball-detent style lock, with sliding motion). This may also translate to substantial weight savings versus preload capacity – for instance, one exemplary ERM may have a 4000 lb. preload capacity and a weight of 1.17 lb. with approximately 10.6 cubic inches of volume. Conversely, an unoptimized prototype has a 8500 lb. preload capacity, and a weight of 0.66 lb., with 5.96 cubic inches of volume.

Embodiments of the present disclosure may use a three-stage mechanism, to release a split spool pair retaining a preloaded release rod. The first stage may use rollers to bear against the outside surface of the split spool, and the inside surface of the release barrel fitting. The rollers may be biased in the self-releasing direction.

The second stage may use a single flapper fitting to prevent the release barrel from rotating, by engaging a face cut into the outside face of the barrel. The flapper fitting may be biased in the self-releasing direction.

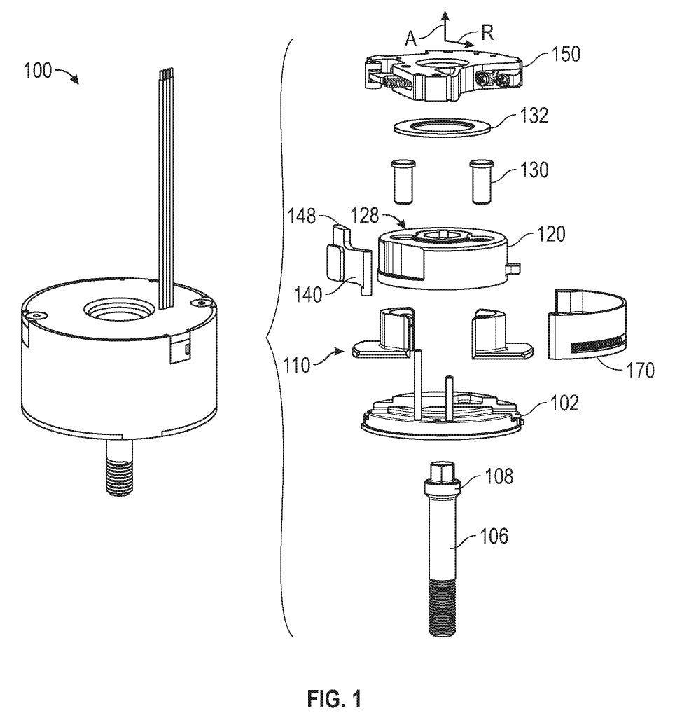

The third stage may use a trigger, to retain the flapper against the release barrel sear face. The trigger may be biased in the self-holding direction. The trigger may be designed as a modular assembly, including the trigger, a frame, and an actuator (e.g., either a TiNi, or a fuze wire). For instance, an exemplary overall arrangement of a prototype according to an embodiment of the present disclosure is shown in FIG. 1.

Referring now to FIG. 1 a hold down and release mechanism 100 according to exemplary embodiments will be described. Hold down and release mechanism (HDRM) 100 may define an axial direction A, a radial direction R, and a circumferential direction C. It should be noted that the directions are include for means of reference only, and that elements of HDRM 100 may be orientated in any suitable position according to specific embodiments.

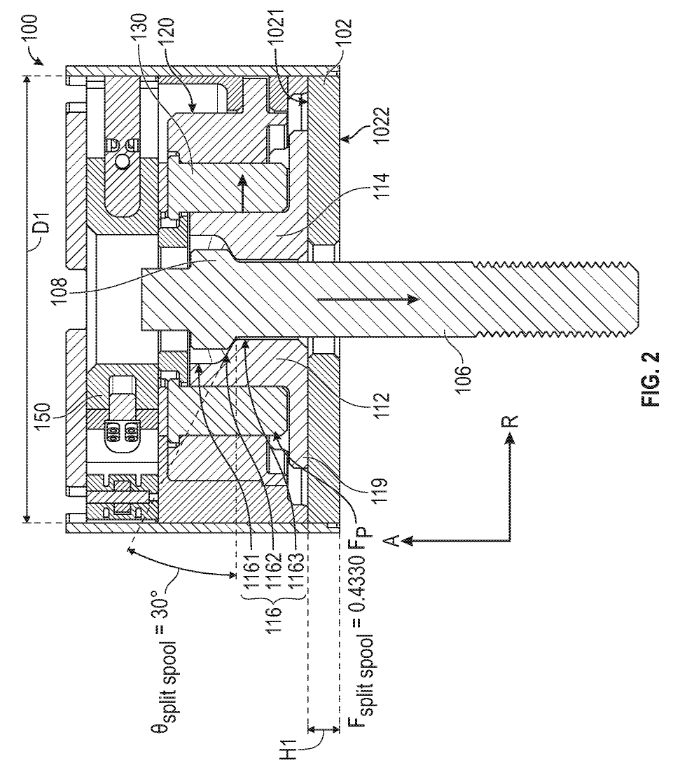

HDRM 100 may include a base plate 102. Base plate 102 may define a diameter D1 (FIG. 2) along the radial direction R. Additionally or alternatively, base plate 102 may define a height H1 along the axial direction A. For instance, base plate 102 may include a top surface 1021 and a bottom surface 1022. Height H1 may be a distance between top surface 1021 and bottom surface 1022. Height H1 may between about 10% and about 20% of diameter D1.

Base plate 102 may have a groove 104 formed therein. Groove 104 may extend along the radial direction R. Groove 104 may extend the entire diameter D1 of base plate 102. For instance, groove 104 may have open ends defined at either radial extreme thereof. According to some embodiments, baseplate 102 defines a circumferential wall. In such cases, the open ends may be more narrow than groove 104. Groove 104 may be formed into top surface 1021 of base plate 102 (e.g., downward along the axial direction A). A depth of groove 104 may be between about 60% and about 90% of height H1 of base plate 102.

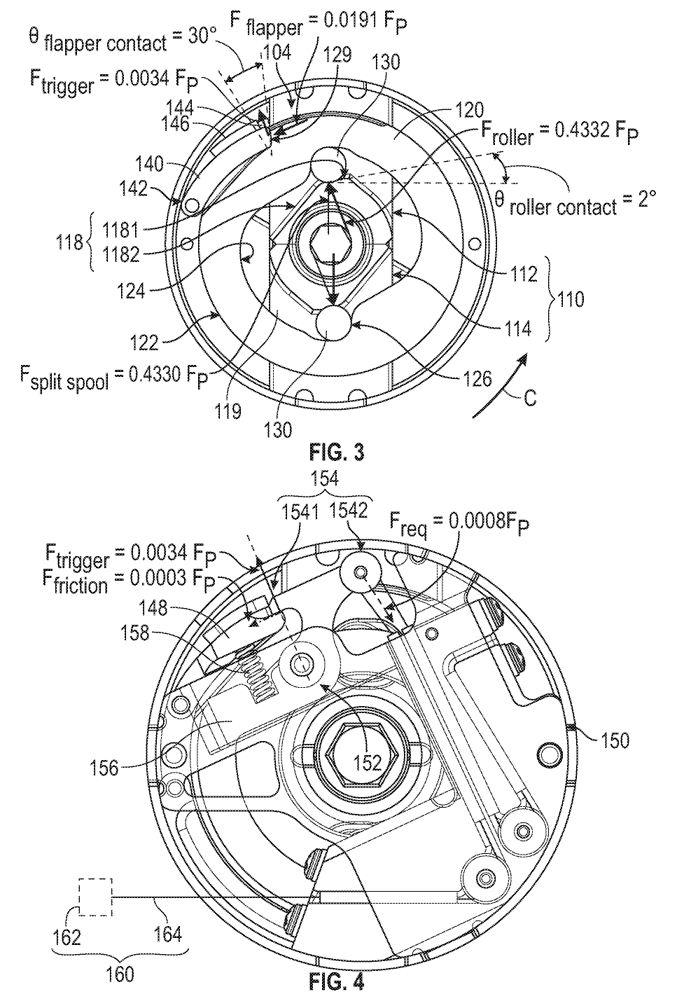

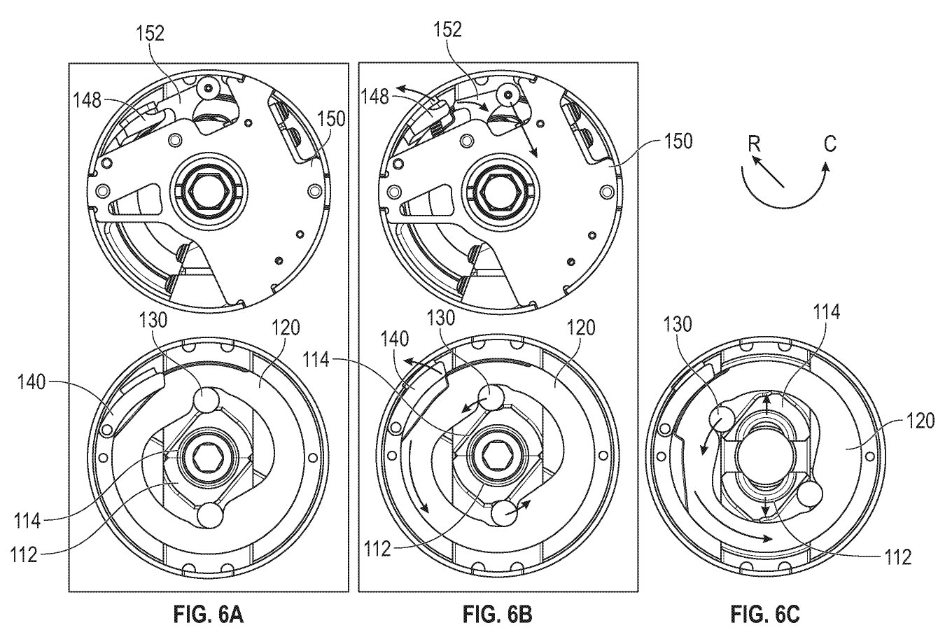

HDRM 100 may include a spool assembly 110. Spool assembly 110 may be in operable contact with base plate 102. For instance, spool assembly 110 may be slidably received within groove 104 of base plate 102. Spool assembly 110 may include a first spool member 112 and a second spool member 114. First spool member 112 and second spool member 114 may be configured to slide along the radial direction R opposite each other. For instance, when first spool member 112 slides along a first direction, second spool member 114 may slide along a second direction opposite the first direction. As will be explained, spool assembly 110 may be movable between a loaded position (e.g., FIG. 3) and an unloaded or released position (e.g., FIG. 6C). When in the loaded position, at least a portion of first spool member 112 may abut at least a portion of second spool member 114. Spool assembly 110 may define a through hole provided at an axial center of HDRM 100.

HDRM 100 may be configured to selectively retain a release rod 106. In detail, release rod 106 may be attached to a payload to be selectively released by HDRM 100 (e.g., in orbit). Release rod 106 may include a head section 108 provided at a first end thereof. Head section 108 may have a diameter greater than a diameter of a main body of release rod 106. Head section 108 may be selectively restrained via spool assembly 110. For instance, head section 108 may be positioned between first spool member 112 and second spool member 114 when in the loaded position (e.g., FIG. 2).

Spool assembly (or split spool) 110 may have an internal geometry which retains head section 108 of release rod 106 by reacting an axial preload in release rod 106 into lateral forces which act to spread spool assembly 110 apart (e.g., Fₛₚₗᵢₜ spool in FIG. 2). Typically, this is achieved with a conic (or modified conic) geometry on the inside surfaces of spool assembly 110. The angle may vary between about 30 degrees and about 45 degrees. In one exemplary prototype device, the angle was set to 30 degrees.

Hereinafter, first spool member 112 will be described with the understanding that the description applies to each of first spool member 112 and second spool member 114. First spool member 112 may include an inner face (or inner circumferential face) 116. Inner face 116 may extend along the circumferential direction C and face toward a radial center of HDRM 100. Inner face 116 may include a first portion 1161, a second portion 1162, and a third portion 1163. First portion 1161, second portion 1162, and third portion 1163 may be defined sequentially along the axial direction (e.g., toward base plate 102).

First portion 1161 may define a first radius R1 while third portion 1163 may define a second radius R2. First radius R1 may be greater than second radius R2. For instance, first radius R1 may be sized to accommodate head section 108 of release rod 106 therein. Second portion 1162 may define a frustoconical shape. For instance, second portion 1162 may taper each of radially inward and axially downward (e.g., toward base plate 102) from first radius R1 to second radius R2. Accordingly, inner face 116 may resemble a funnel extending downward along the axial direction A toward base plate 102. Advantageously, head portion 108 of release rod 106 may slide down second portion 1162 as spool assembly 110 is moved from the loaded position to the unloaded position.

Similarly, first spool member 112 may include an outer face (or outer circumferential face) 118. As would be understood, outer face 118 may be provided opposite inner face 116. For instance, outer face 118 may at least partially face outward along the radial direction R. Outer face 118 may define or include a first portion 1181 and a second portion 1182. It should be noted that outer face 118 may include additional portions as certain applications warrant.

According to some examples, first portion 1181 and second portion 1182 may each be at least relatively linear portions. For instance, each of first portion 1181 and second portion 1182 may extend in straight lines (e.g., as opposed to having curvature). However, it should be understood that each of first portion 1181 and second portion 1182 may have or exhibit some curvature according to specific embodiments, and the disclosure is not limited to the examples provided herein. With reference particularly to FIG. 3, first portion 1181 may extend at an angle with respect to a radial line defined through a center point of HDRM 100. For instance, first portion 1181 may extend at an alpha angle with respect to groove 104. According to at least some embodiments, the alpha angle may be between about 80 degrees and about 89 degrees with respect to groove 104. In other words, first portion 1181 may extend at an angle of between about 1 degree and about 10 degrees with respect to a tangential line perpendicular to groove 104 (e.g., as seen in FIG. 3). Additionally or alternatively, first portion 1181 may extend for a predetermined length. The predetermined length may be between about 10% and about 25% of a total width of groove 104. However, it should be understood that the ranges provided herein are by way of example only, and the disclosure is not limited to the ranges or measurements provided herein.

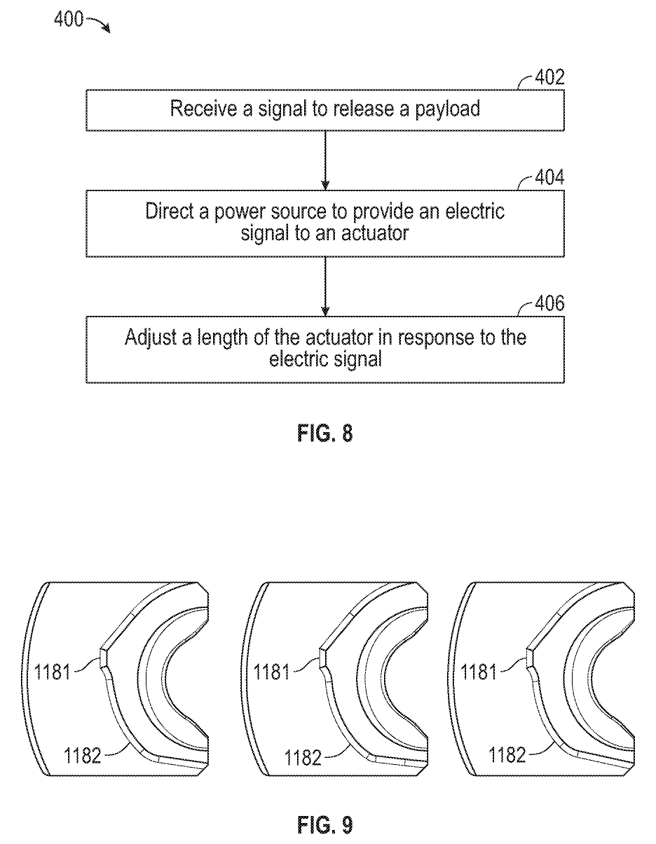

According to some examples, second portion 1182 may extend from a distal end of first portion 1182. Second portion 1182 may extend at a beta angle with respect to groove 104. For instance, the beta angle may be between about 25 degrees and about 45 degrees with respect to groove 104. Additionally or alternatively, second portion 1182 may have a predetermined length. The predetermined length of second portion 1182 may be between about 40% and about 60% of the total width of groove 104. However, as explained above, it should be understood that the ranges provided herein are by way of example only, and the disclosure is not limited to the ranges or measurements provided herein. As will be described below, roller 130 may be configured to roll along each of first portion 1181 and second portion 1182 as spool assembly 100 is moved from the loaded position to the unloaded position. FIG. 8 provides alternate embodiments of shapes, lengths, and curvatures of each of first portion 1181 and second portion 1182. For instance, as shown in FIG. 9, each of first portion 1181 and second portion 1182 may include a convex curvature (e.g., radially outward) with one or more breaks at varying distances therealong.

First spool member 112 may include a flange (or a first flange) 119. Flange 119 may extend along the radial direction R. For instance, flange 119 may extend away from second spool member 114 along the radial direction R. Flange 119 may be received within groove 104 of base plate 102. Additionally or alternatively, a width of flange 119 may be substantially similar to the width of groove 104. Thus, flange 119 may assist in restricting a movement of first spool member 112 to a predominantly linear path within groove 104. Flange 119 may further be accommodated beneath a release barrel (explained below). Thus, flange 119 may restrict or prevent a movement of first spool member 112 along the axial direction A.

HDRM 100 may include a release barrel 120. Release barrel 120 may be positioned around at least a portion of spool assembly 110 (e.g., along the circumferential direction C). Release barrel 120 may be predominantly ring shaped or donut shaped. For instance, release barrel 120 may include an outer circumferential surface 122 and an inner circumferential surface 124. An outer diameter of release barrel 120 (e.g., at outer circumferential surface 122) may be less than diameter D1 of base plate 102. Additionally or alternatively, release barrel 120 may be configured to rotate with respect to each of base plate 102 and spool assembly 110.

Inner circumferential surface 124 may define at least one hard stop or hard stop geometry 126. In detail, inner circumferential surface 124 may define a serpentine path (e.g., as seen from a top view as in FIG. 3). Thus, an inner diameter of release barrel 120 along inner circumferential surface 124 may vary along the circumferential direction C. Thus, a thickness of release barrel 120 (e.g., along the radial direction R) may vary about the circumferential direction C. Hard stop 126 may be defined at a portion of inner circumferential surface 124 where the thickness of release barrel 120 increases from a minimal point to a maximal point. For instance, while advancing along a counterclockwise direction along the circumferential direction, the inner diameter may decrease at hard stop 126. Additionally or alternatively, two or more hard stops 126 may be included. According to at least one example, two hard stops 126 are defined at inner circumferential surface 124 opposite each other along the radial direction R. Advantageously, hard stops 126 may prevent one or more rollers 130 (described below) from becoming dislodged due to vibration or shock. Thus, spool assembly 110 (e.g., spool members 112 and 114) may be maintained in the closed or loaded position to avoid a premature release from vibration.

HDRM 100 may include a roller 130. According to at least some embodiments, two rollers 130 are included. Hereinafter, a single roller 130 will be described for the sake of brevity with the understanding that the description applies to any suitable number of rollers 130 included in specific embodiments. Roller 130 may be positioned or provided between spool assembly 110 and release barrel 120 (e.g., along the radial direction R). Roller 130 may be configured to roll along an outer surface of spool assembly 110. Additionally or alternatively, roller 130 may roll along inner circumferential surface 124 of release barrel 120. Accordingly, roller 130 may facilitate a movement of release barrel 120 with respect to spool assembly 110.

According to some embodiments, roller 130 is accommodated within a roller accepting groove 128. Roller accepting groove 128 may be formed into release barrel 120. For instance, roller accepting groove 128 may be a generally cylindrical aperture formed along the axial direction A into release barrel 120. Roller 130 may thus rotate within roller accepting groove 128 as release barrel 120 is rotated about the circumferential direction C. According to such embodiments, roller 130 may not roll along inner circumferential surface 124 of release barrel 120. Additionally or alternatively, one or more friction reduction elements may be included between roller 130 and roller accepting groove 128 (e.g., such as a bearing, a grease, a Teflon, an oil, or the like).

Additionally or alternatively, in some instances, roller groove 128 may be sized to allow roller 130 to roll far enough such that a preload force is relieved (e.g., as spool assembly 110 separates). The rolling motion may ensure that when friction is relatively large (e.g., due to the large normal force arising from reacting the preload), the various components (e.g., rollers 130, release barrel 120, spool assembly 110, etc.) can still move relatively freely. Once a majority of the preload is relieved, additional rotation of release barrel 120 may result in rollers 130 sliding (e.g., within roller groove 128). However, because a normal force is comparatively small, friction from sliding may also be small, and may not inhibit additional motion required to fully release rod 106.

Roller 130 may impart forces on spool assembly 110. For instance, a lateral split-spool force may be reacted by the rollers in a first stage mechanism (Fᵣₒₗₗₑᵣ in FIG. 3, first stage shown in FIG. 6A). To bias the rollers in a self-releasing direction, a small ramp angle is introduced by the outside profile of spool assembly 110 (e.g., first spool member 112), as shown in FIG. 3. According to at least some embodiments, this ramp angle is between 1-10 degrees (e.g., as mentioned above), in the area where the rollers contact when the mechanism is locked (e.g., in the loaded position). According to one example, an angle of 2 degrees is used. As shown, the angle of the outside profile of spool assembly 110 (e.g., first spool member 112) steepens to provide sufficient relief for the spool members to fully open (e.g., moving along first portion 1181 to second portion 1182), as the release barrel continues to rotate (e.g., from the loaded position to the unloaded position). Tailoring the profiles and relative lengths of the shallow and steep portions of the exterior surface of spool assembly 110 allows for the defining of preload release characteristics of HDRM 100.

Features on both the outside surfaces of spool assembly 110 (e.g., first spool member 112 and second spool member 114) and the inside surfaces of release barrel 120 (e.g., inner circumferential surface 124) may ensure that rollers 130 are fully constrained via hard stop geometries (e.g., hard stop 126), when the mechanism is in the loaded or locked position. The inside surface of release barrel 120 may be contoured to provide sufficient surface for the rollers to roll off of the initial shallow angled portion of the outside profile of first spool member 112. Accordingly, a preload in release rod 106 may be relieved purely by rolling motion of rollers 130. Once the preload is relieved, sliding motion between rollers 130 and spool assembly 110 is acceptable, since the friction forces will be small, in the absence of the large preload force. Additionally or alternatively, HDRM 100 may include a roller retainer 132. Roller retainer 132 may be positioned above release barrel 120 and roller 130 along the axial direction A. Roller retainer may be predominantly ring shaped and may prevent an axial movement of roller 130 with respect to release barrel 120.

HDRM 100 may include a flap tab 140. Flap tab 140 may selectively restrain a rotation of release barrel 120 (e.g., along the circumferential direction C). As shown in FIG. 3, flap tab 140 may be position radially outward from release barrel 120. Flap tab 140 may include a pivot end 142 and a free end 144. Flap tab 140 may thus be rotatable about pivot end 142 such that free end 144 is movable between an engaged position and a disengaged position. For instance, release barrel 120 may include a catch portion 129 formed into an outer circumferential surface thereof. Free end 144 may be configured to selectively engage with catch portion 129 to restrain release barrel 120 from rotating.

According to at least some embodiments, a catch face of catch portion 129 may be configured to contact an edge portion of free end 144 of flap tab 140. The catch face may be orientated at an angle with respect to a bisecting line the central point of HDRM 100. For instance, as seen in FIG. 3, a flapper contact angle may be between about 10 degrees and about 45 degrees. The angle of the catch face may reduce a force required to push flap tab 140 from the engaged position to the disengaged position to allow release barrel 120 to rotate.

Flap tab 140 may include a tab buffer 146. Tab buffer 146 may be positioned along a radially outward face of flap tab 140. Tab buffer 146 may include a resilient or soft material. For instance, tab buffer 146 may include a rubber, felt, poly material, or the like. Accordingly, tab buffer 146 may provide a buffer, padding, or other cushion between flap tab 140 and an outer casing of HDRM 100 as flap tab 140 moves from the engaged position to the disengaged position.

At least a portion of flap tab 140 may extend along the axial direction A. For instance, flap tab 140 may include a flap lock 148 (FIG. 1) extending at free end 144 upward along the axial direction A above a top face of release barrel 120. As best seen in FIG. 1, flap lock 148 may be positioned above release barrel 120 along the axial direction A. As will be described below, a trigger may selectively interact with flap lock 148 to maintain flap tab in the engaged position until a launch or release signal is received.

Additionally or alternatively, rollers 130 may impart tangential forces into release barrel 120, causing it to attempt to rotate about the axial direction A. As explained above, flap tab 140 is configured to prevent this rotation by applying a force (e.g., F_{flapper}) against catch portion 129 formed into the exterior surface of release barrel 120. The contact angle between flap tab 140 and catch portion 129 may be between 10 and 30 degrees, relative to the radial direction R (e.g., as shown in FIG. 3), producing an outward (e.g., self-releasing) force component (e.g., F_{trigger}). The contact angle may be sufficient such that the resulting self-releasing force overcomes the friction between flap tab 140 and release barrel 120. In one example, this was set to 20 degrees.

Moreover, free end 144 of flap tab 140 may be retained by a simple pivoting trigger (e.g., at pivot end 142).The axis of rotation of the trigger (described below) may be placed directly below the contact surfaces of flap tab 140 and the trigger, such that a flap tab retention force produces no moment, making the trigger self-holding. An additional spring may be used to provide a further self-holding biasing load, as well as a resetting force to return an actuator (e.g., a TiNi wire, described below) to its original length, when power is removed. Both features are shown in FIG. 4. The trigger may also be geometrically balanced about its axis of rotation, such that linear accelerations do not generate a moment about the axis. This may provide resistance to uncommanded or unintentional trigger actuation, under vibration or shock loads. The actuator force must overcome the friction force between flap tab 140 and the trigger (e.g., F_{friction}) as well as the biasing force of the trigger spring to release the flapper fitting.

HDRM 100 may include a trigger pack 150. Trigger pack 150 may be operably coupled to release barrel 120. For instance, trigger pack 150 may be configured to selectively interact with flap tab 140 (e.g., according to mechanical or electrical inputs). Trigger pack 150 may be configured to release spool assembly 100 (e.g., via flap tab 140) in response to the input. In some instances, trigger pack 150 is positioned above release barrel 120 along the axial direction A. However, a general position of trigger pack 150 may vary according to specific applications and the disclosure is not limited to the examples provided herein.

Trigger pack 150 may include a trigger or trigger member 152. Trigger member 152 may be at least partially received within a trigger housing. Trigger member 152 may be configured to rotate about a trigger axis. For instance, the trigger axis may be parallel with the axial direction A. Additionally or alternatively, the trigger axis may be offset from each of the central point of HDRM 100 and the flapper axis.

Trigger member 152 may include a first arm 154 and a second arm 156. First arm 154 may extend from the trigger axis along a first direction while second arm 156 may extend from the trigger axis along a second direction. The first direction may be different from the second direction. According to some embodiments, an angle between the first direction and the second direction is between about 110 degrees and about 130 degrees. However, according to specific embodiments, the angle between the first direction and the second direction may be between 0 degrees and 180 degrees. For instance, in some embodiments, the first direction and the second direction may be parallel with each other. Thus, the extending directions of first arm 154 and second arm 156 may vary according to specific embodiments and the disclosure is not limited to the examples provided herein. Additionally or alternatively, each of first arm 154 and second arm 156 may extend at least partially outward along the radial direction R from the trigger axis. For instance, first arm 154 and second arm 156 may balance each other about the trigger axis (e.g., a pivot axis of trigger member 152).

First arm 154 may include a hammer catch 1541. In detail, hammer catch 1541 may be positioned at a first side of first arm 154. Hammer catch 154 may extend from a distal end of first arm 154 toward flap tab 140. Hammer catch 1541 may selectively interact with flap tab 140. For instance, hammer catch 1541 may be configured to selectively restrain flap tab 140 in the engaged position. Hammer catch 1541 may thus be in contact with flap lock 148 when flap tab 140 is in the engaged position. Hammer catch 1541 may restrict a radially outward motion of flap tab 140. Thus, in the loaded or engaged position, hammer catch 1541 may be position radially outward from flap tab 140 (e.g., from flap lock 148).

First arm 154 may include a pulley 1542. Pulley 1542 may be positioned at a second side of first arm 154 (e.g., opposite hammer catch 1541). Pulley 1542 may be configured to rotate. For instance pulley 1542 may rotate about a pulley axis defined in parallel with the axial direction A. However, in some instances, pulley 1542 may remain rotationally stationary or locked. Additionally or alternatively, pulley 1542 may be configured to accommodate a wire, rope, line, or the like therearound. Additionally or alternatively, pulley 1542 may be or include an insulator or wire retainer to restrain or retain the wire therearound. In one or more embodiments, the pulley 1542 may electrically isolate the wire. As will be explained, as the wire is manipulated (e.g., as an actuator or in response to an actuator), first arm 154 may be pulled to rotate trigger member 152 about the trigger axis. As the trigger member 152 is rotated, hammer catch 1541 may release flap tab 140 allowing release barrel 120 to rotate and subsequently allow spool assembly 110 to separate.

Trigger pack 150 may include an actuator 160. As mentioned, actuator 160 may be operably coupled with pulley 1542. Actuator 160 may include a power source 162 and an actuation portion 164. Power source 162 may be positioned externally to trigger pack 150. Power source 162 may be an electric or electronic power source. For instance, power source 162 may be configured to produce a predetermined voltage or current to be delivered to actuation portion 164.

Actuation portion 164 may be provided within trigger pack 150 (e.g., within a trigger housing). Actuation portion 164 may include a wire, line, rope, or the like. As mentioned, actuation portion 164 may be operably connected with pulley 1542. According to at least some embodiments, actuation portion 164 includes a shape metal alloy (SMA) wire. As would be understood, the SMA wire may be configured to adjust one or more properties in response to an input (e.g., an electrical input). For instance, a length of the SMA wire may be adjusted in response to an electrical stimulus. Additionally or alternatively, actuator 160 may include a fuse wire. For instance, the fuse wire may be provided at or near power source 162 or actuation portion 164. The fuse wire may be configured to prevent or reduce the risk of excessive current flow (e.g. current flow above a threshold) through actuation portion 164.

Trigger pack 150 may include a flap spring 158. Flap spring 158 may be positioned between trigger member 152 and flap tab 140. For instance, flap spring 158 may be operably connected between second arm 156 of trigger member 152 and flap lock 148. Flap spring 158 may include a resilient biasing member, such as a coil compression spring. Accordingly, flap lock 148 (and subsequently flap tab 140) may be biased outward along the radial direction R via flap spring 158. When hammer catch 1541 of trigger member 152 is in the engaged position, flap spring 158 may be in an energized state. Accordingly, when trigger member 152 is rotated (e.g., via actuator 160) and hammer catch 1541 releases flap lock 148, flap spring 158 may assist in pushing flap tab 140 out from catch portion 129 to thus allow release barrel 120 to rotate.

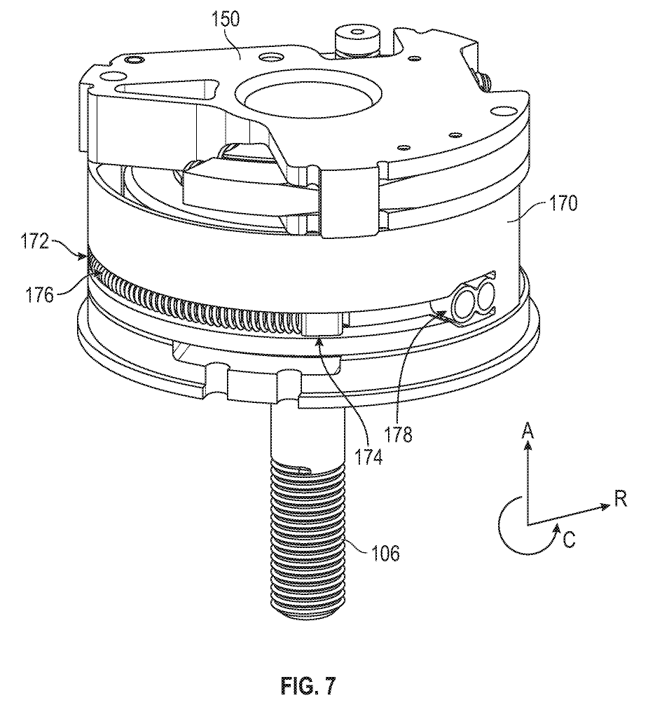

HDRM 100 may include a barrel bracket or spring guide fitting 170. Referring particularly to FIGS. 1 and 7, spring guide fitting 170 may at least partially surround release barrel 120 along the circumferential direction C. For instance, spring guide fitting 170 may be semi-circular extending over a predetermined arc length about release barrel 120. Spring guide fitting 170 may include a spring guide slot 172. Spring guide slot 172 may be formed into spring guide fitting 170 and may extend along the circumferential direction C (e.g., over at least a portion of a total arc length of spring guide fitting 170). For instance, spring guide slot 172 may include a circumferential groove or aperture (see, e.g., FIG. 7) allowing communication through spring guide fitting 170.

Release barrel 120 may include a driving tab 174. Driving tab 174 may extend from the outer circumferential surface of release barrel 120 along the radial direction R. Driving tab 174 may be at least partially accommodated within spring guide slot 172 of spring guide fitting 170. As release barrel 120 rotates, driving tab 174 may slide within spring guide slot 172 along the arc length thereof.

Spring guide fitting 170 may include a driving spring 176. Driving spring 176 may be accommodated within spring guide slot 172. Driving spring 176 may include a resilient or biasing element, such as a coil compression spring. Driving spring 176 may be operably coupled with driving tab 174. For instance, when release barrel 120 is rotated into the loaded position, driving tab 174 may compress driving spring 176 into an energized state. Driving spring 176 may thus assist in rotating release barrel 120 when flap tab 140 is moved to the disengaged position, thus allowing spool assembly 100 to separate. For example, in the instance where no preload force is present to automatically drive the rotation of release barrel 120, driving spring 176 may ensure a rotation of release barrel 120. Advantageously, release barrel 120 may thus include redundant initiation or actuation.

Spring guide fitting 170 may further include a shock absorber 178. Shock absorber 178 may be provided at a terminus of spring guide slot 172. Shock absorber 178 may be integrally formed within spring guide fitting 170 (e.g., as one integral piece). Shock absorber 178 may be configured to attenuate a shock from driving tab 174 contacting the terminus point of spring guide slot 172 after actuation. Thus, shock absorber 178 may be at least partially malleable or resilient. In some instances, additional or alternative biasing elements may be included, such as buffers, rubbers, springs, or the like.

Now that the general description of an exemplary hold down and release mechanism has been described, a method 400 of operating a hold down and release mechanism will be described. Method 400 may be applicable to any suitable release system (e.g., such as HDRM 100). It should be noted that method 400 may omit certain steps, may include additional steps, or may adjust or alter the order in which actions occur. Hereinafter, method 400 will be described with reference to FIG. 8.

At 402, method 400 may include receiving a signal to release a preloaded assembly (e.g., a payload) via a hold down and release mechanism (HDRM). As mentioned above, the HDRM may be capable of selectively releasing a preloaded assembly (e.g., a satellite, equipment, etc.) at a determined time. Thus, the signal may be associated with a particular time point, location, or other trigger for releasing the preloaded assembly. The signal may include one or more electronic signals (e.g., from one or more sensors), manual directives (e.g., from an astronaut or pilot), or automatic triggers. It should be noted that any suitable signal may be incorporated and the disclosure is not limited to the examples provided herein.

At 404, method 400 may include directing a power source to provide an electric signal to an actuator in response to receiving the signal. For instance, the HDRM may include an actuator (e.g., actuator 160) including a power source (e.g., power source 162). In some instances, the power source is an electrical power source, capable of generating an electrical signal (e.g., a voltage signal, a current draw, etc.). The power source may be connected with an actuation element (e.g., actuation portion 164). In additional or alternative embodiments, the power source may be configured to produce or generate a mechanical action. For instance, the power source may include a motor, gear system, or the like.

At 406, method 400 may include adjusting a length of the actuator in response to the electric signal. For instance, as mentioned above, the actuator may include a shape memory alloy (SMA) capable of adjusting a shape or length in response to an electronic stimulus. The SMA may be operably connected with a trigger (e.g., trigger member 152). Thus, when the length of the SMA is adjusted, the trigger may be manipulated to release a tab (e.g., flap tab 140). Upon the manipulation of the trigger, the attached payload may be released via a splitting of a spool assembly (e.g., spool assembly 110).

A total mechanical advantage (preload capacity divided versus trigger actuator force) may be typically between 800:1 to 3000:1. An exemplary prototype was found to have a total mechanical advantage of approximately 1400:1.

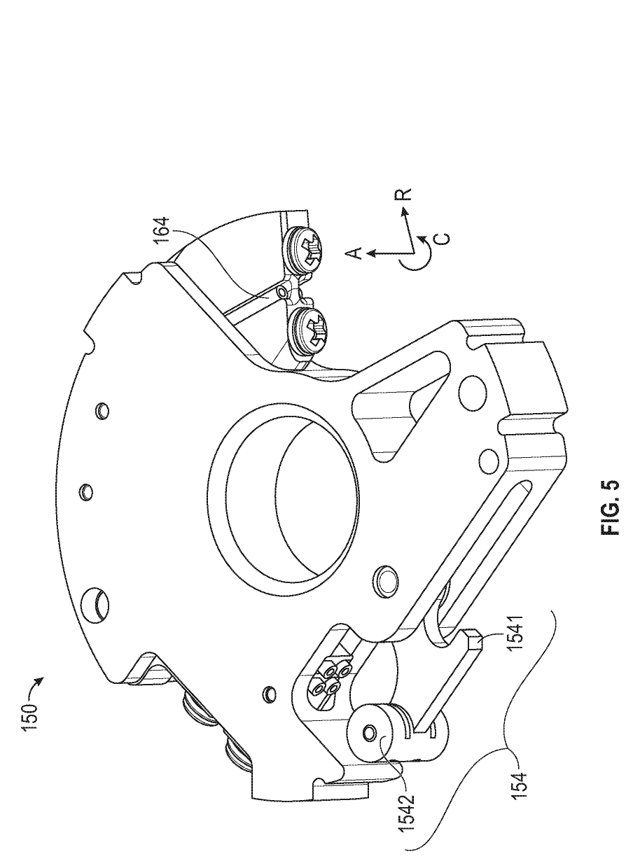

The trigger assembly may integrate the trigger and actuator into a modular frame, (e.g., as shown in FIG. 5). This may allow the trigger to be rigged and tested independently from the rest of the mechanism, using appropriate tooling. Application of electric current to either one (or both) of the TiNi wires may cause them to contract, pulling the trigger, and releasing a flapper fitting. Redundant TiNi actuators may be used. For instance, the exemplary prototype uses a dual-redundant arrangement, with electrically-isolated TiNi loops. Any single TiNi loop may provide sufficient force to release the mechanism.

The use of a modular trigger assembly may also allow the use of different trigger actuator types with a common release mechanism. One example may include a single-use fuse-wire trigger assembly variant, providing higher operational temperatures than a TiNi-based resettable mechanism. In this case, the trigger spring may bias the trigger to release, with the trigger retained by the fuse wire. When functioned, the fuse wire may melt, releasing the trigger. Resetting this type of unit would involve replacing the trigger assembly as a self-contained field-replaceable module.

Resetting the unit may be achieved by manually rotating the release barrel into the locked position, and pressing the flapper fitting inwards, until it is engaged by the trigger.

Under normal (preloaded) operation, the preload may provide all of the required force to actuate the mechanisms, once the trigger is released. However, to ensure the invention functions in off-nominal conditions where the preload has been lost prior to actuation, two biasing springs may be included – one to actuate the release barrel, and one to actuate the flapper fitting. In an exemplary prototype device, the flapper fitting and trigger share the same biasing spring. The release barrel biasing spring may be fitted in a guide fitting, that runs around the outside of the release barrel. The spring may engage a tab that projects out from the body of the release barrel. This tab may also engage a shock absorbing feature integrated into the spring guide fitting, when the barrel reaches end of travel, as shown in FIG. 7.

The detailed description explains embodiments of the disclosure, together with advantages and features, by way of example with reference to the drawings.

The term “about” is intended to include the degree of error associated with measurement of the particular quantity based upon the equipment available at the time of filing the application.

It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

What is claimed is:

1. A hold down and release mechanism, the hold down and release mechanism defining an axial direction, a radial direction, and a circumferential direction, the hold down and release mechanism comprising:
a base plate;
a spool assembly comprising at least one first spool member and a second spool member in operable contact with the base plate;
a release barrel positioned around the spool assembly;
a pair of rollers provided between the spool assembly and the release barrel, the pair of rollers configured to roll along an outer surface of the spool assembly; and
a trigger pack operably coupled to the release barrel, wherein the spool assembly is configured to separate in response to an input from the trigger pack.

2. The hold down and release mechanism of claim 1, further comprising:
a flap tab selectively restraining a rotation of the release barrel, wherein the flap tab comprises a pivot and a free end opposite the pivot end, the flap tab being rotatable about the pivot end between an engaged position and a disengaged position.

3. The hold down and release mechanism of claim 2, wherein the trigger pack comprises:
a trigger member, the trigger member being rotatable about a trigger axis, the trigger member being balanced about the trigger axis.

4. The hold down and release mechanism of claim 3, wherein the trigger member further comprises:
a first arm comprising a hammer catch positioned at a first side of the first arm, wherein the hammer catch selectively restrains the flap tab in the engaged position; and
a pulley positioned at a second side of the first arm opposite the hammer catch.

5. The hold down and release mechanism of claim 4, wherein the trigger pack further comprises:
an actuator operably coupled with the trigger member, wherein the actuator is configured to rotate the trigger member in response to an input.

6. The hold down and release mechanism of claim 5, wherein the actuator comprises a shape metal alloy (SMA) wire.

7. The hold down and release mechanism of claim 6, further comprising a fuse wire operably coupled with the actuator.

8. The hold down and release mechanism of claim 5, wherein the trigger pack, the trigger member, the pulley, and the actuator are provided as a single self-contained modular pack.

9. The hold down and release mechanism of claim 1, wherein the first spool member comprises a first inner circumferential surface and the second spool member comprises a second inner circumferential surface, the first inner circumferential surface defining a first portion, a second portion, and a third portion, and the second inner circumferential surface comprising a fourth portion, a fifth portion, and a sixth portion.

10. The hold down and release mechanism of claim 9, wherein the first portion and the fourth portion each define a first radius, wherein the third portion and the sixth portion each define a second radius, and wherein the second portion and the fifth portion each define a frustoconical shape.

11. The hold down and release mechanism of claim 10, wherein the first radius is greater than the second radius.

12. The hold down and release mechanism of claim 10, wherein the frustoconical shape connects the first portion with the third portion and the fourth portion with the sixth portion.

13. The hold down and release mechanism of claim 9, wherein the base plate defines a groove extending along the radial direction, the groove being formed into a top surface of the base plate, and wherein the spool assembly is slidably received within the groove.

14. The hold down and release mechanism of claim 13, wherein the first spool member comprises a first outer circumferential surface and the second spool member comprises a second outer circumferential surface.

15. The hold down and release mechanism of claim 14, wherein the first outer circumferential surface defines a first portion and a second portion, and wherein the second outer circumferential surface defines a third portion and a fourth portion.

16. The hold down and release mechanism of claim 15, wherein each of the first portion and the third portion extend at an angle of between 1 degree and 10 degrees with respect to a tangential line along the first outer circumferential surface and second outer circumferential surface respectively.

17. The hold down and release mechanism of claim 9, wherein the first spool member comprises a first flange extending along the radial direction and the second spool member comprises a second flange extending along the radial direction opposite the first flange.

18. The hold down and release mechanism of claim 17, wherein the pair of rollers comprises a first roller in rolling contact with the first spool member and a second roller in rolling contact with the second spool member.

19. The hold down and release mechanism of claim 1, wherein the release barrel comprises an inner circumferential surface and an outer circumferential surface, the inner circumferential surface defining at least one hard stop geometry configured to restrain the pair of rollers along the circumferential direction.

20. A method of operating a hold down and release mechanism, the hold down and release mechanism comprising an actuator and a power source operably coupled with the actuator, the method comprising:
receiving a signal to release a preloaded assembly via the hold down and release mechanism;
directing the power source to provide an electric signal to the actuator in response to receiving the signal; and
adjusting a length of the actuator in response to the electric signal, wherein at least a portion of the actuator is positioned around a trigger such that the actuator rotates the trigger as the length of the actuator is adjusted.
